(19) United States
(12) Patent Application Publication
(10) Pub. No.: US 2024/0429361 A1
(43) Pub. Date: Dec. 26, 2024

(54) Method for Producing a Mark, Method for Producing an Energy Storage Cell, and Motor Vehicle

(71) Applicant: Bayerische Motoren Werke Aktiengesellschaft, Muenchen (DE)

(72) Inventors: Martin HILLER, Karlsfeld (DE); Martin ZIER, Rosenheim (DE)

(21) Appl. No.: 18/274,009

(22) PCT Filed: Feb. 7, 2022
(86) PCT No.: PCT/EP2022/052830

§ 371 Date: Jul. 25, 2023

(30) Foreign Application Priority Data
Mar. 9, 2021 (DE) 10 2021 105 584.9

(51) Int. Cl. H01M 4/04; C23C 26/00

(52) U.S. Cl. CPC H01M 4/0402; C23C 26/00

(57) ABSTRACT

A method for producing a mark where a substrate is coated with a coating material includes: applying the coating material to a substrate; and aligning components in the coating material by way of a magnetic field, in order to produce at least one mark in or on the coating mate

### BACKGROUND AND SUMMARY

The present invention relates to a method for producing a mark, a method for producing an energy storage cell, and a motor vehicle.

Energy storage cells of the type under discussion are, for example, lithium-ion battery cells. Independently of the cell type, the smallest unit of such energy storage cells comprises two electrodes and a separator which separates the electrodes from one another. The conductive electrolyte is located in between. The electrodes are in turn typically formed by coated carrier foils. The coating materials for the anode and the cathode are generally different, but they typically contain components such as an active material, conductive carbon black, solvent, binder, and further additives. The carrier foils are preferably metallic, web-structured foils, which are initially provided in the form of rolls. In production, it is often necessary to ensure a certain tracking capability, for example, for quality assurance. The uncoated edge areas of the carrier foils can be provided with a colored mark or the like for the implementation of the tracking. Since these edge areas are cut off in the further course of the process, however, the marks are also lost. A colored mark of the coating itself is excluded so as not to negatively influence the electrochemical properties of the cell.

It is therefore an object of the present disclosure to specify a method for producing a mark, a method for producing energy storage cells, and a motor vehicle, wherein the above-mentioned problems are solved and in particular energy storage cells and a motor vehicle are to be specified which meet the highest quality requirements.

This object may be achieved by a method and a motor vehicle according to the independent claims. Further advantages and features may result from the dependent claims and the description and the appended figures.

According to this disclosure, a method for producing a mark, wherein a carrier material is coated using coating material, comprises the following steps: applying coating material to a carrier material; and aligning components in the coating material to generate at least one mark in or on the coating material via a magnetic field.

The method advantageously utilizes the circumstance that components of the coating material can be attracted or repelled via the application of a magnetic field, for example using a magnetic device, such as an (electro) magnet. Structuring of the coating material can be achieved by the (re-)alignment of these components resulting therefrom, which results in an optical change, in particular of a surface of the coating material, such that it can be used and perceived as a mark. Items of information can advantageously be generated and transferred via the optical change of the coating. Alternatively, such a mark can also be used as a design element.

If a material is subjected to an external magnetic field, magnetization of the material thus takes place. The direction and strength of this magnetization is based on intrinsic properties of the material and is characterized by the terms diamagnetism, paramagnetism, and ferromagnetism. The magnetization of material in an external field, thus the alignment of the elementary magnets in the material, can be counter to or in the same direction as the external magnetic field. In diamagnetism, the magnetization is counter to the external field. In paramagnetic bodies, the magnetization is in the same direction as the external magnetic field. In ferromagnetic materials, the magnetization is in the same direction as the external magnetic field and is particularly strong due to a special interaction of the electron spins, the so-called exchange interaction. The magnetization of ferromagnetic materials is generally significantly greater with equal external magnetic field than the magnetization of paramagnetic materials. The present method is independent of the underlying principle.

According to one preferred embodiment, the method is used to mark an electrode of a battery cell, such as a lithium-ion battery/accumulator.

According to one embodiment, the carrier material is designed as a metallic, web-structured foil. A carrier foil for the anode is typically a copper foil, the carrier foil for the cathode is typically an aluminum foil. The coating can be performed intermittently or continuously on one or both sides.

According to one preferred embodiment, the mentioned components are graphite particles. The graphite particles are part of the coating. Graphite is diamagnetic. It has been shown that, for example, after applying a magnetic field, the coating appears darker in an area of converging field lines than in an area without the magnetic field. It is thus advantageously possible to generate marks, structures, and/or structuring by letting one (or more) magnetic fields act in a targeted manner.

According to one embodiment, a magnetic device is used for generating the magnetic field and for aligning the components. According to one preferred embodiment, the method comprises the following step: using one or more electromagnets or an electric coil to generate a magnetic field and align the components.

Such systems may advantageously be integrated without great expenditure in existing (coating) facilities. According to one embodiment, for example, electromagnets are used to align the components.

According to one embodiment, the method is controlled so that the magnetic field acts directly and immediately on the respective coated area. Alternatively, the magnetic field may act on an opposite side of the area just coated. Via a strength of the magnetic field, it is expediently possible to set, among other things, whether the mark is generated on both sides of the (two-sided) coated carrier material.

According to one embodiment, the method comprises the following step: generating the at least one mark immediately after the application of the coating material.

The magnetic components can be aligned as long as the coating material is not cured or is not completely cured.

According to one embodiment, the method comprises the following step: analyzing the coating material and/or optically acquiring and assessing the coating material to determine the position of the at least one mark.

According to one embodiment, for example, the items of information of an application tool, via which the coating is applied, are acquired and processed. It can thus possibly already be recognized that an error was present in the coating process. Additionally or alternatively, the coating material can be detected and checked using optical acquisition devices, such as a camera, in order to recognize whether an error is possibly present. This or possibly multiple points can then advantageously be marked accurately in position via the magnetic device.

According to one embodiment, the method comprises the following step: acquiring and evaluating the at least one mark in the further production process for analysis.

Since the mark is advantageously applied directly to the coating, it can be used during the entire production process, for example, for component tracking. This is accompanied by significant advantages with respect to the flexibility of the application.

According to one embodiment, the method comprises the following step: forming a plurality of marks for, for example, error identification, component tracking, or production monitoring.

The web meters foil rollers/electrode rollers used are advantageously trackable down to the cell level.

According to one embodiment, the method comprises the following step: generating the at least one mark at an edge area of the coating.

The influence on the electrochemistry, which possibly takes place due to the alignment of the magnetic components, can thus expediently be reduced to a minimum. However, it is not precluded that one or more marks can also be provided in other areas of the coating, for example also in the middle, in particular if an error was recognized at this point in any case.

According to one embodiment, the method comprises the following step: fixing the mark.

This can be implemented, for example, by the application of a protective layer, such as a clear lacquer. In particular if the (coated) carrier material is not provided for use in a galvanic element, but rather is to be used as a design element, for example in a vehicle interior, the structure/mark can thus be permanently retained.

The invention also relates to a method for producing an energy storage cell, wherein the method according to the invention is used to produce a mark in the context of the manufacturing or production.

The invention also relates to a motor vehicle, which comprises at least one energy storage cell, which was produced according to the method according to the invention. Typical motor vehicles of the type under discussion are, for example, hybrid vehicles or also completely electrically operated vehicles, wherein these can be motorcycles, passenger vehicles, or also utility vehicles.

Further advantages and features result from the following description of embodiments of the method with reference to the appended figures.

### BRIEF DESCRIPTION OF THE FIGURES

In the figures:

FIG. 1: shows a top view of a coated carrier foil in a schematic illustration;

FIG. 2: shows a schematic illustration of an embodiment of a method for producing an energy storage cell.

### DETAILED DESCRIPTION OF THE FIGURES

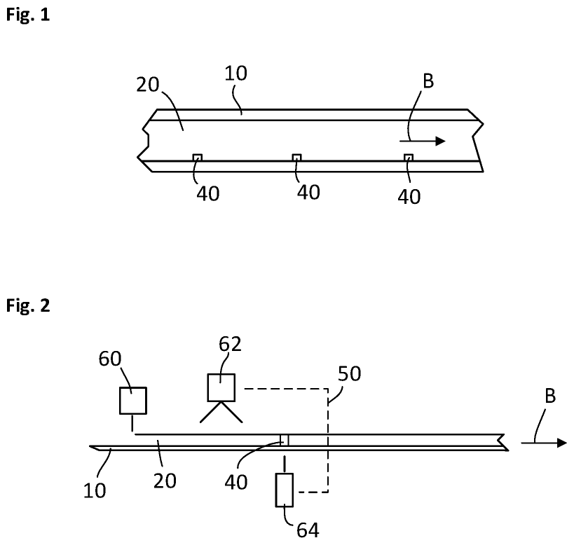

FIG. 1 shows a schematic illustration of a top view of a carrier material 10, wherein this can be a metallic carrier foil in this case, for example, wherein it is moved along a web direction B. The carrier material 10 has a coating or is coated using a coating material 20. It can be seen that marks 40 are provided in the edge areas of the coating. These were generated via an alignment of components in the coating material 20. In this way, for example, a tracking capability of the web meters used of the carrier material 10 down to the cell level is possible.

FIG. 2 shows a schematic view of a coating process, wherein a carrier material 10 is coated using coating material 20 via an application tool 60. The carrier material 10 is moved along a web direction B. A quality of the coating material or the coating application is evaluated via a detection device 62, for example an optical acquisition device, comprising, for example, one or more cameras. The detection device 62 is connected to a magnetic device 64, cf. the reference sign 50. Upon recognition of an error via the detection device 62, the magnetic device 64 can precisely mark the position of the corresponding error, cf. the reference sign 40. The corresponding area can thus be recognized later and, for example, removed or reworked.

### LIST OF REFERENCE SIGNS

10 carrier material
20 coating material
40 mark
50 data exchange
60 application tool
62 detection device
64 magnetic device
B web direction

1-11. (canceled)

12. A method for producing a mark, the method comprising:
applying a coating material to a carrier material;
generating a magnetic field; and
aligning components in the coating material using the magnetic field, thereby producing at least one mark in or on the coating material.

13. The method according to claim 12, wherein
aligning the components in the coating material using the magnetic field effects an optical change in a surface of the coating material.

14. The method according to claim 12, wherein
the at least one mark is produced during manufacture of an electrode for a battery cell, the electrode comprising the carrier material.

15. The method according to claim 12,
wherein the carrier material comprises a metallic, web-structured foil.

16. The method according to claim 12,
wherein the components include graphite particles.

17. The method according to claim 12, wherein
generating the magnetic field comprises using one or more electromagnets or an electrical coil.

18. The method according to claim 12, wherein
the at least one mark is produced immediately after the application of the coating material.

19. The method according to claim 12, wherein
the components in the coating material are aligned prior to curing of, or prior to complete curing of, the coating material.

20. The method according to claim 12, further comprising:
analyzing the coating material and/or optically acquiring and assessing the coating material to determine the position of the at least one mark.

21. The method according to claim 12, further comprising:
acquiring and evaluating the at least one mark in a further production process for analysis.

22. The method according to claim 12, further comprising:
forming a plurality of marks in or on the coating material for error identification, component tracking, or production monitoring.

23. The method according to claim 12, wherein
the at least one mark is produced at an edge area of the coating.

24. The method according to claim 12, comprising at least two marks, wherein
the at least two marks are produced in or on the coating material on both sides of the carrier material.

25. The method according to claim 12, further comprising:
applying a protective layer on the coating material to fix the at least one mark.

26. A method for producing an energy storage cell comprising the method according to claim 12.

27. A motor vehicle comprising at least one energy storage cell produced by the method according to claim 26.
